(19) United States
(12) Patent Application Publication
(10) Pub. No.: US 2013/0098649 A1
(43) Pub. Date: Apr. 25, 2013

(54) Support frame for a jack hammer

(71) Applicants: Dominick Charbonneau, Hawksbury (CA); Richard Lauzon, St-Marthe (CA)

(72) Inventors: Dominick Charbonneau, Hawksbury (CA); Richard Lauzon, St-Marthe (CA)

(21) Appl. No.: 13/656,678

(22) Filed: Oct. 20, 2012

(30) Foreign Application Priority Data
Oct. 20, 2011 (GB) 1118145.0

(51) Int. Cl. B25D 17/28; B25D 17/32

(52) U.S. Cl. 173/185; 173/31

(57) ABSTRACT

A Support frame for a jack hammer has an armature comprised of a riser member rotationally attached to a vertical support member. The vertical support member extends perpendicularly from a base having wheels, casters, and pods. Extending diagonally from the vertical support member is a joystick support member to which is movably attached a joystick. The joystick has a handle at one of its end and an attachment ring at its opposite end to attach the bottom of the jack hammer. The joystick runs through a sleeve which is rotationally attached to a cross beam. The sleeve allows for the joystick to slide therethrough.

### FIELD OF THE INVENTION

The present invention relates generally to tools but more particularly to a support frame for a jack hammer.

### BACKGROUND OF THE INVENTION

Jack hammers are not the best tools to operate because their intense vibrations can be the cause of a variety of ailments ranging from lower back pain to carpal tunnel syndrome by way of disrupting blood circulation. Also, they are heavy and difficult to move around. There needs to be a beterway to use jack hammers.

### SUMMARY OF THE INVENTION

In view of the foregoing disadvantages inherent in the known devices now present in the prior art, the present invention, which will be described subsequently in greater detail, is to provide objects and advantages which are:

To provide for a support frame which separates the jack hammer from the operator so as to eliminate any problem related to the operation of a jack hammer.

In order to do so, the invention consists of a base member adapted to remain stable upon a flat surface. An armature attached to the base member and extending vertically therefrom wherein the armature includes a riser member rotationally attached to a vertical support member that is securely attached to the base member.

The riser member includes a handle at one end and two cradle members at an opposite end adapted to hold handles of a jack hammer, such that the riser member is adapted to pivot upon the vertical support member and thereby lift or lower the jack hammer vertically from the flat surface.

A joystick member adapted to attach to a portion of the jack hammer a distance from the jack hammer handles. The joystick includes a handle portion, and an attachment portion or ring adapted to attach securely to the jack hammer, and a joystick support member attached to the vertical support member and extending in a direction in proximity to the riser handle.

The joystick support member includes a sleeve that is fixedly attached to a cross beam member, such that the joystick is adapted to slide through the sleeve and attach to the jack hammer, thereby offering the ability of the support frame to manipulate the jack hammer in a variety of positions desirable.

The support frame has the base member include at least two wheels and at least one pod member, such that the support frame can be rolled along a surface and placed stably at a desired location.

The base member further includes at least one caster member, such that the base member can be pivoted upon the wheels until the at least one caster member contacts the flat surface and the at least one pod member is spaced from the flat surface, rolled along a surface, then pivoted in an opposite direction such that the at least one pod member contacts the flat surface and the at least one caster member is spaced from the flat surface, such that the support frame is stable once again upon the flat surface at a different location.

The support frame further comprises a locking means connected between the riser member and the joystick support member, such that the jack hammer is adapted to be locked in a raised position above the flat surface.

The support frame has the at least one pod member comprise two pod members spaced from one another on a front portion of the base member.

The support frame has the at least one pod member comprise two caster members spaced from one another on a back portion of the base member and opposite side thereof from the wheel members.

The support frame has the joystick support member attached to the vertical support member at a diagonal angle between 91 and 180 degrees as compared to a horizontal reference plane of the base member.

The support frame has the joystick member adapted to be attached to the jack hammer using the attachment ring that is adapted to be easily and securely removably attached to a curved cross-section of a jack hammer.

The support frame is further comprised of a flood light attached to a front portion of the base member; and power cable attached to the riser member. The invention works in combination with a jack hammer.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter which contains illustrated preferred embodiments of the invention.

### BRIEF DESCRIPTION OF THE DRAWINGS

FIG. 1 Isometric view of the invention.

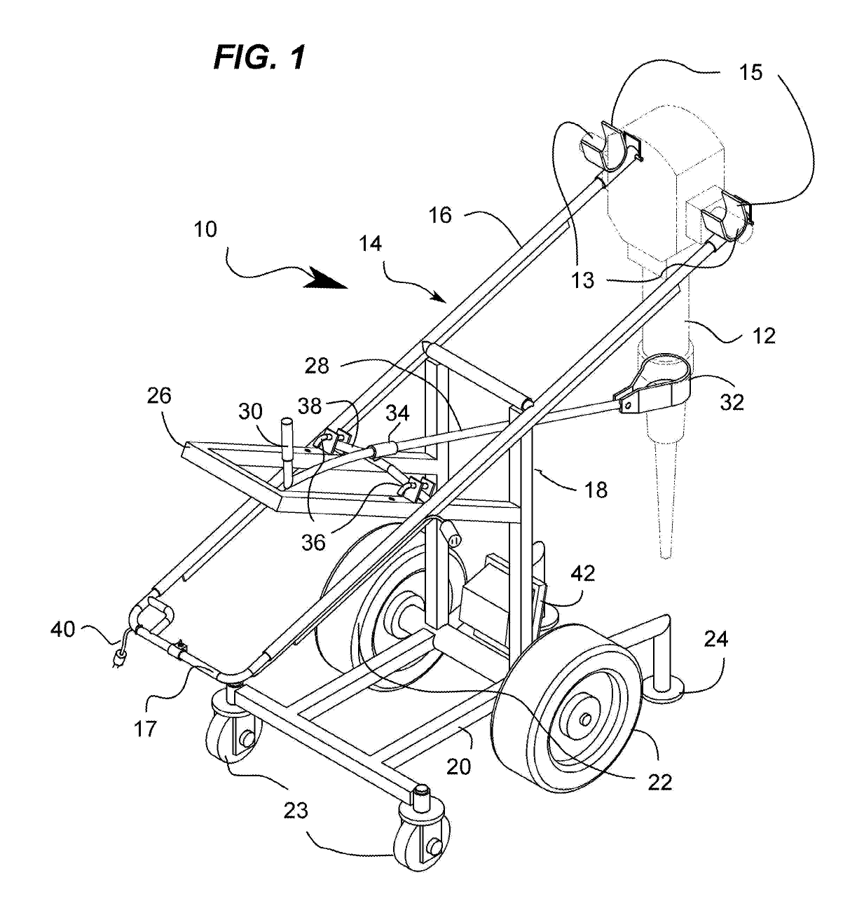

FIGS. 2a-c Top, side and front views of the invention.

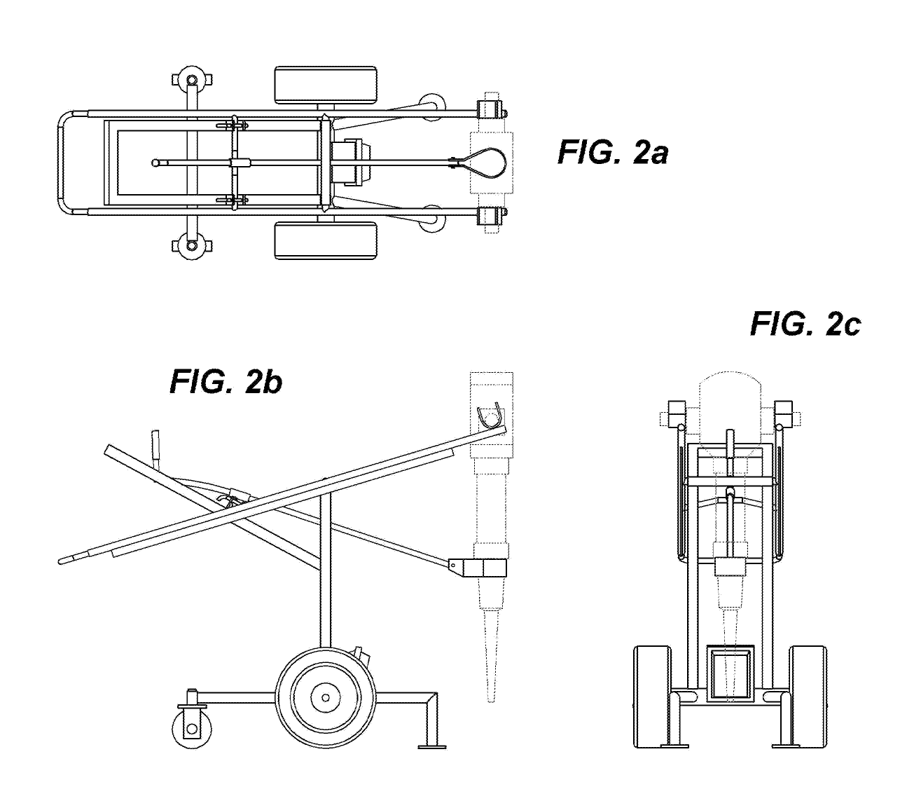

FIGS. 3a-b Side views showing the range of motion of the riser member and the joystick.

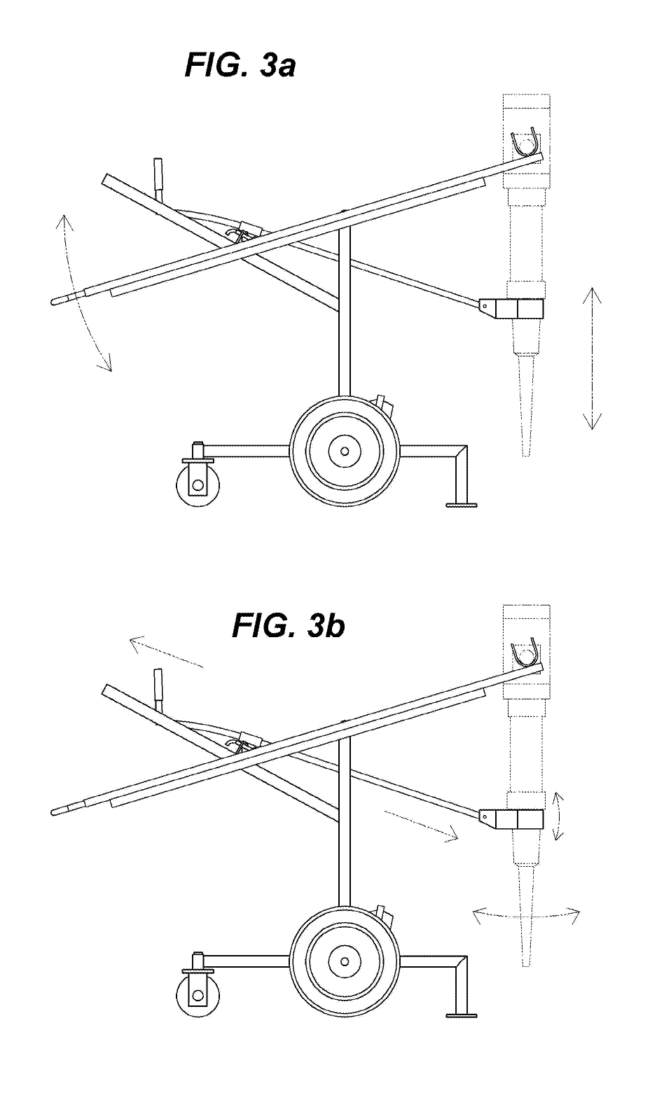

### DETAILED DESCRIPTION OF THE PREFERRED EMBODIMENT

A support frame (10) for a jack hammer (12) has an armature (14) comprised of a riser member (16) rotationally attached to a vertical support member (18).

The vertical support member (18) extends perpendicularly from a base member (20) having wheels (22), casters (23) and pod members (24). The casters (23) allow the support frame (10) to turn while the pods (24) stabilize it in place for hammering. Extending diagonally from the vertical support member (18) is a joystick support member (26) to which is movably attached a joystick (28). The joystick (28) controls the position of the jack hammer's (12) tip.

The joystick (28) has a handle portion (30) at one of its end and an attachment ring (32) at its opposite end to attach the bottom of the jack hammer (12). The joystick (28) runs through a sleeve (34) which is fixedly attached to a cross beam member(38). The cross beam member (38) is itself fixedly attached at both of its extremity to the riser member (16). The sleeve (34) allows for the joystick (28) to slide therethrough.

Locking means (36) located on the joystick support member (26) lock the cross beam (38) and thus lock the riser member (16) in a raised configuration so that the jack hammer (12) is clear above ground when moving the support frame around (10).

The jack hammer (12) is held, by way of its own handles (13), with a pair of cradle members (15).

The riser member (16) can be raised or lowered when a user lowers it by way of a riser handle (17).

Optional features include power cables (40) (or pneumatic cables) and a floodlight (42).

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. For example, punch dies are the preferred tool used but other types of cutters such as rotary drill cutters could be used and still achieve a similar result.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A support frame for a jack hammer comprising a base member adapted to remain stable upon a flat surface; an armature attached to said base member and extending vertically therefrom, said armature including a riser member rotationally attached to a vertical support member that is securely attached to said base member; said riser member includes a handle at one end and two cradle members at an opposite end adapted to hold handles of a jack hammer, such that said riser member is adapted to pivot upon said vertical support member and thereby lift or lower said jack hammer vertically from said flat surface; a joystick member adapted to attach to a portion of said jack hammer a distance from said jack hammer handles; said joystick including a handle portion, and an attachment portion adapted to attach securely to said jack hammer; and a joystick support member attached to said vertical support member and extending in a direction in proximity to said riser handle; said joystick support member includes a sleeve that is fixedly attached to a cross beam member, such that said joystick is adapted to slide through said sleeve and attach to said jack hammer, thereby offering the ability of said support frame to manipulate said jack hammer in a variety of positions desirable.

2. The support frame of claim 1, wherein said base member includes at least two wheels and at least one pod member, such that said support frame can be rolled along a surface and placed stably at a desired location.

3. The support frame of claim 2, wherein said base member further includes at least one caster member, such that said base member can be pivoted upon said wheels until said at least one caster member contacts said flat surface and said at least one pod member is spaced from said flat surface, rolled along a surface, then pivoted in an opposite direction such that said at least one pod member contacts said flat surface and said at least one caster member is spaced from said flat surface, such that said support frame is stable once again upon said flat surface at a different location.

4. The support frame of claim 1, further comprising a locking means connected between said riser member and said joystick support member, such that said jack hammer is adapted to be locked in a raised position above said flat surface.

5. The support frame of claim 2, wherein said at least one pod member comprises two pod members spaced from one another on a front portion of said base member.

6. The support frame of claim 3, wherein said at least one pod member comprises two caster members spaced from one another on a back portion of said base member and opposite side thereof from said wheel members.

7. The support frame of claim 1, wherein said joystick support member is attached to said vertical support member at a diagonal angle between 91 and 180 degrees as compared to a horizontal reference plane of said base member.

8. The support frame of claim 1, wherein said joystick member is adapted to be attached to said jack hammer using an attachment ring that is adapted to be easily and securely removably attached to a curved cross-section of a jack hammer.

9. The support frame of claim 1, further comprising a flood light attached to a front portion of said base member; and power cable attached to said riser member.

10. A combination of a jack hammer and a support frame, said combination comprising a jack hammer; and a base member adapted to remain stable upon a flat surface; an armature attached to said base member and extending vertically therefrom, said armature including a riser member rotationally attached to a vertical support member that is securely attached to said base member; said riser member includes a handle at one end and two cradle members at an opposite end adapted to hold handles of a jack hammer, such that said riser member is adapted to pivot upon said vertical support member and thereby lift or lower said jack hammer vertically from said flat surface; a joystick member adapted to attach to a portion of said jack hammer a distance from said jack hammer handles; said joystick including a handle portion, and an attachment portion adapted to attach securely to said jack hammer; and a joystick support member attached to said vertical support member and extending in a direction in proximity to said riser handle; said joystick support member includes a sleeve that is fixedly attached to a cross beam member, such that said joystick is adapted to slide through said sleeve and attach to said jack hammer, thereby offering the ability of said support frame to manipulate said jack hammer in a variety of positions desirable.

11. The combination of claim 10, wherein said base member includes at least two wheels and at least one pod member, such that said support frame can be rolled along a surface and placed stably at a desired location.

12. The combination of claim 11, wherein said base member further includes at least one caster member, such that said base member can be pivoted upon said wheels until said at least one caster member contacts said flat surface and said at least one pod member is spaced from said flat surface, rolled along a surface, then pivoted in an opposite direction such that said at least one pod member contacts said flat surface and said at least one caster member is spaced from said flat surface, such that said support frame is stable once again upon said flat surface at a different location.

13. The combination of claim 10, further comprising a locking means connected between said riser member and said joystick support member, such that said jack hammer is adapted to be locked in a raised position above said flat surface.

14. The combination of claim 11, wherein said at least one pod member comprises two pod members spaced from one another on a front portion of said base member.

15. The combination of claim 12, wherein said at least one pod member comprises two caster members spaced from one another on a back portion of said base member and opposite side thereof from said wheel members.

16. The combination of claim 10, wherein said joystick support member is attached to said vertical support member at a diagonal angle between 91 and 180 degrees as compared to a horizontal reference plane of said base member.

17. The combination of claim 10, wherein said joystick member is adapted to be attached to said jack hammer using an attachment ring that is adapted to be easily and securely removably attached to a curved cross-section of a jack hammer.

18. The combination of claim 10, further comprising a flood light attached to a front portion of said base member; and power cable attached to said riser member.
